(19) United States
(12) Patent Application Publication
(10) Pub. No.: US 2010/0269918 A1
(43) Pub. Date: Oct. 28, 2010

(54) SYSTEM AND APPARATUS FOR PROCESSING FLUID SAMPLES

(76) Inventor: Eric Rudolph, Ambler, PA (US)

Correspondence Address: MILLIPORE CORPORATION, 290 CONCORD ROAD, BILLERICA, MA, 01821, US

(21) Appl. No.: 12/452,745

(22) PCT Filed: Jul. 18, 2008
(86) PCT No.: PCT/US08/08838

§ 371 Date: May 28, 2010

Related U.S. Application Data
(60) Provisional application No. 60/963,015, filed on Aug. 2, 2007.

(51) Int. Cl. F16L 3/00; F15D 1/00

(52) U.S. Cl. 137/343; 137/561 R; 137/544; 137/565.01

(57) ABSTRACT

A system and apparatus (10) is provided for processing fluid reagents (12, 14, 16, 18) comprising disposable fluid conduits and a reusable conduit support system (20). The fluid conduits are connected to at least one source of fluid and to at least one unit operation (22) such as filtration.

### CROSS-REFERENCE TO RELATED APPLICATIONS

This application claims the benefit of priority of U.S. Provisional Patent Application No. 60/963,015, filed on Aug. 2, 2007, the entire contents of which are incorporated by reference herein.

### FIELD OF THE INVENTION

This invention relates to a system and apparatus for processing fluid reagents utilizing disposable fluid conduits. More particularly, this invention relates to such a system and apparatus which utilizes a reusable conduit support system and apparatus.

### BACKGROUND OF THE INVENTION

Prior to the present invention, fluid samples have been processed in systems including rigid flow paths such as those formed of stainless steel and working units such as pumps which are connected to zones where unit operations, such as fluid reactions between samples and reagents are effected. The piping design and lay-out of these systems ensures that the systems minimize hold-up and are easily drained and vented. These features allow the user to repeatedly manufacture product and regenerate the system to appropriate hygienic standards.

These systems are developed by laboratory testing wherein relatively low volume systems are employed. These low volumes systems then are scaled up to the relatively high volume commercial units. Oftentimes, the laboratory scale systems do not resemble the final commercial scale system. This can lead to errors in the commercial system based on data obtained from the laboratory scale system.

In order to provide greater flexibility in manufacturing and reduce the time needed to effect valid regeneration, manufacturers have begun to utilize disposable systems of disposable tubing and bags that are assembled and used with each product batch. However, due to the flexibility of the tubing and bags, system assembly can be time consuming and render product recovery difficult. Additionally, these flexible systems are being used at intermediate scales, such as from 10 to 1,000 liters with the goal of adapting the process to the scale of current stainless steel systems.

These systems are at times limited in pressure due to the strength of the tubing and lack a unified approach to integrating flow and distribution throughout a circuit.

U.S. Pat. No. 7,001,513 discloses a cassette enclosing a fluid conduit system secured to at least one fluid source and a waste container. The cassette contains a fluid conduit system. The cassette is a fixed apparatus and the fluid conduit system is disposable. The cassette would enable the fluid conduit system to have greater pressure capability and provide a unified/integral sequenced approach for fluid distribution. This approach would replace individual pumps and valves currently employed and consolidate them into the cassette.

Accordingly, it would be desirable to provide a laboratory system and apparatus for testing fluid reagent treatment processes that can be easily scaled up to a commercial system and apparatus. In addition, it would be desirable to provide such a system and apparatus wherein the laboratory scale mode and the commercial mode closely resemble each other. Such a system and apparatus would provide laboratory data which is closely applicable to the commercial system and apparatus.

### SUMMARY OF THE INVENTION

The present invention provides a system and apparatus utilizing disposable fluid conduits and a reusable conduit support system and apparatus. The system and apparatus comprises one or a plurality of conduit support systems having the same fluid paths but at varying volumes. The conduit support system can be opened and closed to permit replacement of a prior used conduit system with a fresh conduit system. The fresh conduit system includes at least one inlet for a fluid and at least one outlet for a fluid as well as at least one unit operation where a fluid is processed such as filtration, chromatography, liquid-liquid extraction or the like. The system and apparatus also is provided with means for effecting fluid flow within the conduit system such as one or more pumps, e.g., peristaltic pumps. The unit operation(s) can be replaced with new unit operation(s) when the conduit system is replaced. A family of reusable conduit support systems (cassettes) and apparatus having essentially the same design but with varying size conduit paths to accommodate varying size conduits can be provided. Such a family of conduit support systems and apparatus permits accurate scale up from low volume laboratory system(s) to relatively large volume commercial system(s).

### BRIEF DESCRIPTION OF THE DRAWINGS

FIG. 1 is a perspective view of the conduit support system of this invention, when closed.

FIG. 2 is a cross sectional view of the system of FIG. 1 showing the conduit, unit operation apparatus and conduit support apparatus.

FIG. 3 is a perspective view of the conduit support system of FIG. 1, when open.

FIG. 4 is a perspective view of the back surface of the system of FIG. 1.

### DESCRIPTION OF SPECIFIC EMBODIMENTS

The present invention provides a reusable conduit support apparatus and system which supports a disposable flexible conduit system. Representative suitable flexible conduit materials include silicone, polyethylene, polypropylene, PTFE resin, C-Flex® resin or the like. The support apparatus and system includes fluid conduit paths having a diameter and shape to provide support for the conduit system during its use when the fluid therein is pressurized. Upon completion of a desired unit operation on a fluid, the conduit support apparatus is opened to expose the flexible conduit system and allow for its removal. The used flexible conduit system then is replaced with a new flexible conduit system which is connected to a reagent supply source, to a reagent recovery system and to at least one unit operation.

It is to be understood that the fluid pathways illustrated in the figures are exemplary only. Any fluid pathway can be utilized.

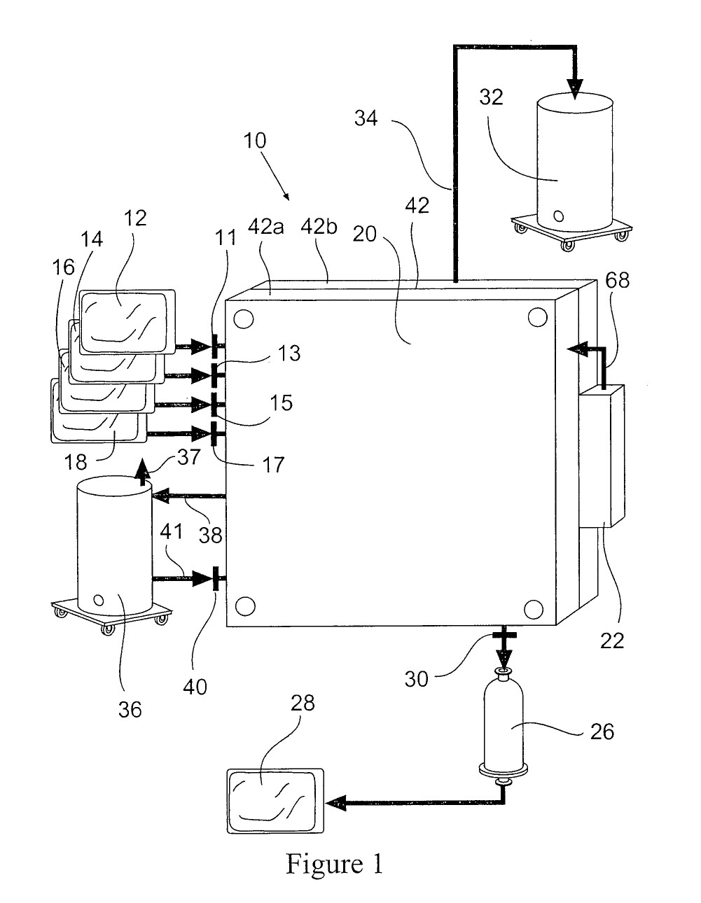

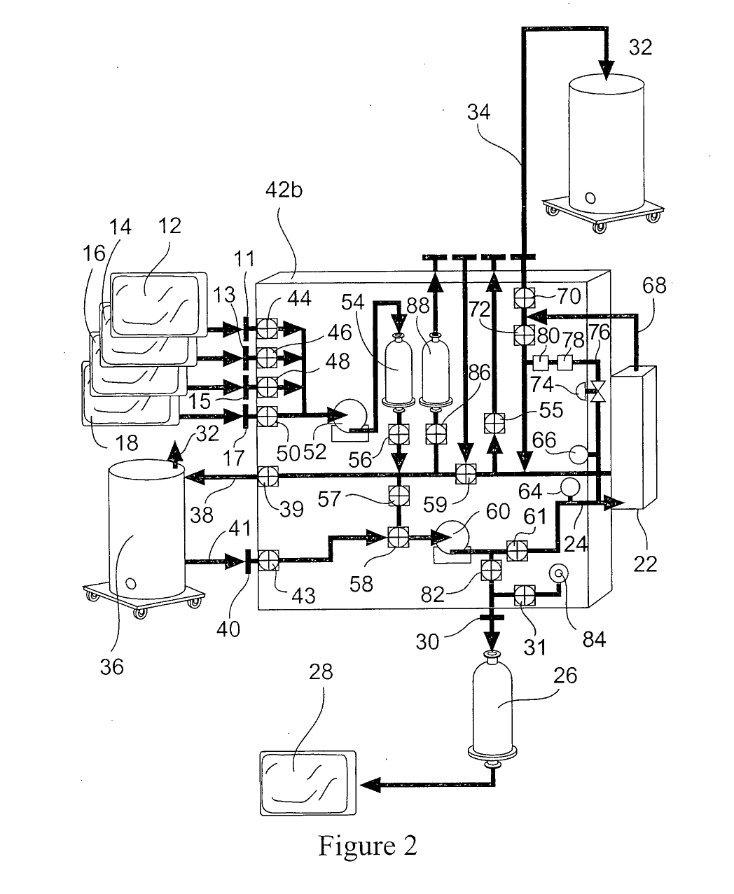

Referring to FIGS. 1 and 2, the manifold system and apparatus of this invention 10 includes reagent supply sources 12, 14, 16 and 18 which are connected to inlets 11, 13, 15 and 17 and a flexible conduit system housed within the manifold 20. A unit operation, such as filtration 22 is also connected to the flexible conduit system at outlet 24. A filter 26 is connected to a reagent recovery container 28 and to an outlet 30 from the manifold 20. A second recovery container 32 is connected to outlet 34 from manifold 20. A third recovery unit 36 for waste product is connected to outlet 38 through valve 39 (FIG. 2) from manifold 20 and is also connected by conduit 41 (FIG. 2) to inlet 40 for recycle of waste product to the flexible conduit system through valve 43 (FIG. 2). Recovery unit 36 is provided with a gas vent 32.

The manifold system 10 comprises a manifold section 42 and having two half sections such as manifold sections 42a and 42b containing the flexible conduit system between them is shown. Optionally, additional sections may be used to subdivide the system as desired. Alternatively, a single section may be used with no second section to provide protection or pressure resistance if neither is necessary or desired. The flexible fluid conduits positioned within the manifold section 42b are shown in black in FIG. 2. The fluid conduits as well as the working units are positioned within properly shaped recesses in the manifold section 42b. Reagents from one or more reagent supply sources 12, 14, 16 or 18 pass through valves 44, 46, 48 and 50 respectively into pump 52. Fluid from pump 52 passes through filter 54, through valves 56, 57 and 58 and into pump 60.

Fluid passes from pump 60 and is directed through valve 61, through outlet 24 and into filtration unit 22. Filtration unit 22 can be connected to pressure transducers 64 and 66 in order to monitor pressure within filtration unit 22. Permeate from filtration unit 22 passes through conduit 68 and out through conduit 34 to recovery unit 32 when valve 70 is open and valve 72 is closed. While recovery unit 32 is shown as a vessel it may also be a plastic bag if desired.

When it is desired to bypass the filtration unit 22, valve 74 is opened and fluid passes through conduit 76, through recording instruments 78 and 80 which measure pH, conductivity, UV or optical density or the like. When valve 56 is open and valve 57 is open while valve 61 is closed and valve 82 is open, fluid can be directed through filter 26 to recovery unit 28. If desired, a sample can be collected in container 84 when valve 31 is open.

When it is desired to vent the fluid conduit system of gas, valve 86 is open, gas passes through filter 88 and out manifold section 42b. At the end of a treatment cycle, valve 59 is open to the atmosphere to let air into the manifold 42. When it is desired to remove waste from the manifold 42, valve 55 is open.

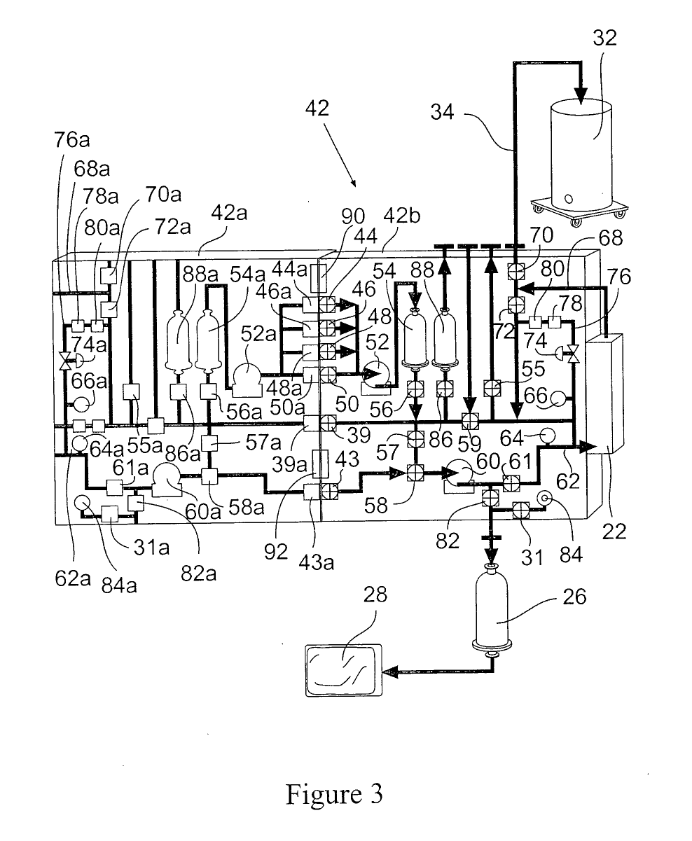

Referring to FIG. 3, the manifold section 42a has recesses which mate with the recesses containing working units, conduits and valves housed in manifold section 42b (FIG. 2). The recesses are sized to permit the conduits to expand under the pressure of the fluid therein but to limit expansion to below that where the conduits burst. In FIG. 3, the recesses in manifold section 42a are marked with an indication number including the letter, a. These recesses enclose the conduits, valves, working units and fluid sample container indicated by the same number but without the a in manifold section 42b. The manifold sections 42a and 42b are connected by hinges 90 and 92.

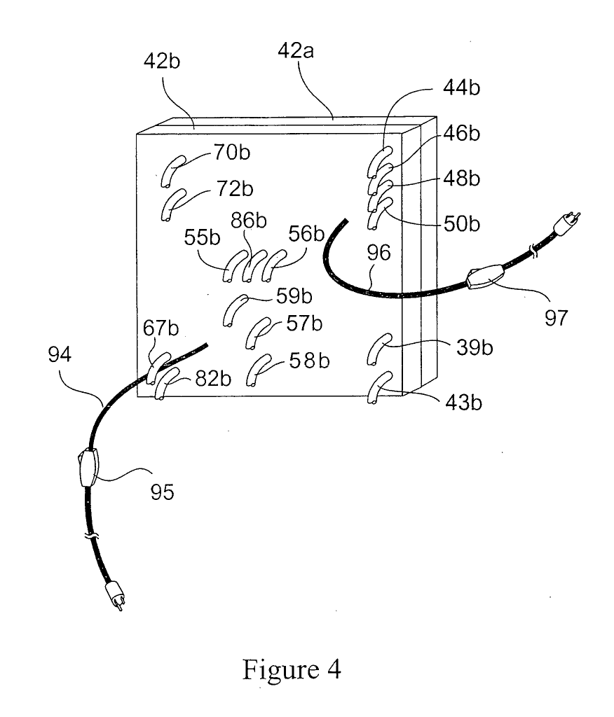

Referring to FIG. 4, electrical outlet 94 having switch 95 is connected to pump 60 (FIG. 2) through the wall of the manifold section 42a or 42b and electrical outlet 96 having switch 97 is connected to pump 52 (FIG. 2) also through the wall of the manifold section 42a or 42b. In FIG. 4, the pneumatic power sources for the valves shown in FIG. 3 are indicated by the same number as the valve to which it is connected followed by the letter b.

What is claimed:

1. An apparatus for processing at least one fluid reagent which comprises:
a disposable set of interconnected fluid conduits;
a source of at least one fluid reagent connected to said fluid conduits;
means for directing flow of said at least one fluid reagent through said fluid conduit;
at least one unit operation for processing said at least one fluid reagent; means for recovering a fluid product from said at least one unit operation; and
a reusable housing for said flow conduits and said means for directing flow of said at least one fluid reagent;

2. A system for processing at least one fluid reagent which comprises a plurality of apparatus, each apparatus having a disposable set of interconnected fluid conduits,
a source of at least one fluid reagent connected to said fluid conduits,
means for directing flow of said at least one fluid reagent through said fluid conduit,
at least one unit operation for processing said at least one fluid reagent, means for recovering a fluid product from said at least one unit operation, the plurality of apparatus having a plurality of sets of interconnected fluid conduits, each of said sets having conduit diameters different from the diameter of the other of said sets of interconnecting fluid conduits, each of said apparatus having a reusable housing for enclosing said fluid conduits sized to enclose one of said sets.

3. A re-usable housing cassette configured to house a set of interconnected conduits and means for directing at least one fluid through said conduits, said cassette functioning to increases the pressure capability of the tubing manifold contained in the cassette and to provide containment of said conduits.

4. The apparatus of claim 1 wherein said unit operation is filtration.

5. The system of claim 2 wherein said unit operation is filtration.

6. The apparatus of claim 1 wherein said unit operation is chromatography.

7. The system of claim 2 wherein said unit operation is chromatography.

8. The system of claim 2 wherein said unit operation is liquid-liquid extraction.

9. The apparatus of claim 1 wherein said means for directing flow comprises at least one peristaltic pump.

10. The system of claim 2 wherein said means for directing flow comprises at least one peristaltic pump.

11. The cassette of claim 3 wherein said means for directing flow comprises at least one peristaltic pump.

12. The apparatus of claim 1 further comprising a plurality of sources of fluid reagents.

13. The system of claim 2 further comprising a plurality of sources of fluid reagents.

14. The apparatus of claim 1 wherein said unit operation is chromatography and further comprising a plurality of sources of fluid reagents.

15. The system of claim 2 wherein said unit operation is liquid-liquid extraction and further comprising a plurality of sources of fluid reagents.

16. The system of claim 2 wherein said unit operation is chromatography and further comprising a plurality of sources of fluid reagents.

17. The apparatus of claim 1 wherein said unit operation is filtration and further comprising a plurality of sources of fluid reagents.

18. The system of claim 2 wherein said unit operation is filtration and further comprising a plurality of sources of fluid reagents.
